(19) United States
(12) Patent Application Publication
(10) Pub. No.: US 2014/0236748 A1
(43) Pub. Date: Aug. 21, 2014

(54) METHOD AND SYSTEM FOR ONLINE PURCHASES BY COLLECTIVE BARGAINING UNITS THAT ARE GENERATED TO ALLOW USERS TO NEGOTIATE BETTER PRICES WITH VENDORS

(71) Applicants: Kiruba Sivasubramaniam HARAN, Clifton Park, NY (US); Suthaharan Sivasubramaniam, San Carlos, CA (US); Vidya Venkataraman Sivasubramaniam, Clifton Park, NY (US)

(72) Inventors: Kiruba Sivasubramaniam HARAN, Clifton Park, NY (US); Suthaharan Sivasubramaniam, San Carlos, CA (US); Vidya Venkataraman Sivasubramaniam, Clifton Park, NY (US)

(21) Appl. No.: 13/771,349

(22) Filed: Feb. 20, 2013

(51) Int. Cl. G06Q 30/06

(52) U.S. Cl. CPC G06Q 30/0605
USPC 705/26.2

(57) ABSTRACT

A method of facilitating a creation of group of customers and soliciting an offer for a plurality of goods or services, which includes enrolling a plurality of consumers in a service for submission of at least one offer to at least one vendor to purchase goods or services; receiving requests for goods and/or services from the plurality of consumers via a networking device; automatically processing requests for goods and/or service from the plurality of consumers to build at least one group request of similar and/or identical goods and/or services for a submission to at least one vendor; and submitting the at least one group request to the at least one vendor on behalf of the plurality of consumers.

### FIELD OF THE INVENTION

The present invention relates to online purchases and a method and system by which collective bargaining units are generated to allow users to negotiate better prices with vendors for virtually any product or service, and more particularly to a method and system for purchasing goods and services of others at a discount via a network such as the Internet, wireless cellular network and/or mobile broadband network.

### BACKGROUND OF THE INVENTION

Typically, the purchase of goods and services between a business and/or vendor and a consumer and/or customer lacks any negotiation between the business and/or vendor and consumer with respect to the terms of a sale or purchase of a good or service. The transaction employs a format whereby the business and/or vendor determines which goods or services to offer for sale, when the goods or services will be offered for sale, and the non-negotiable or fixed price at which the good or service will be sold. This is especially true in online transactions where the interaction between vendors and consumers is limited.

It can be appreciated that businesses or vendors may offer discounts if they have commitment for a large volume order. The vendors benefit by reduced overhead on the sales, and make up for lower margins with increased volume. The customers benefit by being part of a large group that can negotiate a reduced cost. Services like Groupon™, have attempted to address this gap with a system where special deals are negotiated with vendors in return for attaining a predetermined minimum volume. These models are not very scalable because of the custom negotiations and because the vendors typically use this as a promotional event.

Accordingly, it would be desirable to have an automated system and/or method, with limited or no human administration which mutually satisfies the consumer with a discount for the purchase of goods or services, and the business and/or vendor with a number or plurality of sales at a discounted yet commercially viable price. The system needs to have features that encourage participation by a broad set of consumers and vendors, and should be scalable with limited overhead to be a sustainable business model. It would also be desirable to have a system whereby fuzzy, loosely defined customer needs and desires are automatically or with minimal human interaction consolidated in well-defined bundles for vendors to respond to.

### SUMMARY

In accordance with an exemplary embodiment, a method of facilitating a creation of group of customers and soliciting an offer for a plurality of goods or services, the method comprises: enrolling a plurality of consumers in a service for submission of at least one offer to at least one vendor to purchase goods or services; receiving requests for goods and/or services from the plurality of consumers via a networking device; automatically processing requests for goods and/or service from the plurality of consumers to build at least one group request of similar and/or identical goods and/or services for a submission to at least one vendor; and submitting the at least one group request to the at least one vendor on behalf of the plurality of consumers.

In accordance with a further exemplary embodiment, a method of facilitating a creation of group of customers for soliciting an offer for a plurality of goods or services, the method comprises: enrolling a plurality of consumers in a service for submission of at least one group request to at least one vendor to purchase goods or services; receiving requests for goods and/or services from the plurality of consumers via a networking device; suggesting goods and/or services to the plurality of consumers via a networking device; and submitting the at least one group request to the at least one vendor on behalf of the plurality of consumers.

In accordance with another exemplary embodiment, a system for facilitating a creation of customer groups for soliciting an offer for a plurality of goods or services, the system comprises: a system server for managing an application, the application performing the following steps: enrolling a plurality of consumers in a service for submission of at least one group request to at least one vendor to purchase goods or services; receiving requests for goods and/or services from the plurality of consumers via a networking device; grouping the requests for goods and/or service from the plurality of consumers for a submission to at least one vendor; and submitting the at least one group request to the at least one vendor on behalf of the plurality of consumers; and one or more client devices, which receive the customer group application from the system server via a network.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a system for online purchases by a consumer collective service, which includes bargaining units in accordance with an exemplary embodiment.

FIG. 2 is a flow diagram for online purchases by a consumer collective service, which includes bargaining units in accordance with an exemplary embodiment.

FIG. 3 is a flow diagram of a process for adding items to collective bargaining profile in accordance with an exemplary embodiment.

FIG. 4 is a flow diagram of a discount process in accordance with an exemplary embodiment.

FIG. 5 is a flow diagram of a commitment to the deal in accordance with an exemplary embodiment.

FIG. 6 is a flow diagram of sealing the deal in accordance with an exemplary embodiment.

FIG. 7 is a flow chart of an exemplary embodiment for online purchases by a consumer collective service, which includes bargaining units.

FIG. 8 is a flow chart of another exemplary embodiment for online purchases by a consumer collective service, which includes bargaining units.

### DETAILED DESCRIPTION

The present invention relates to a method and system for a customer group service (e.g., service) for online purchases of goods and/or services by which collective bargaining units are generated online to allow users to negotiate better prices with vendors for goods and/or services. It can be appreciated that the methods and systems as described herein can be implemented either as a standalone service or as an application on a social network. In accordance with an exemplary embodiment, the method and system involve a tool (or application), which facilitates the creation of customer groups with minimal effort by the users and/or customers and which provides bargaining power over vendors that participate in the service.

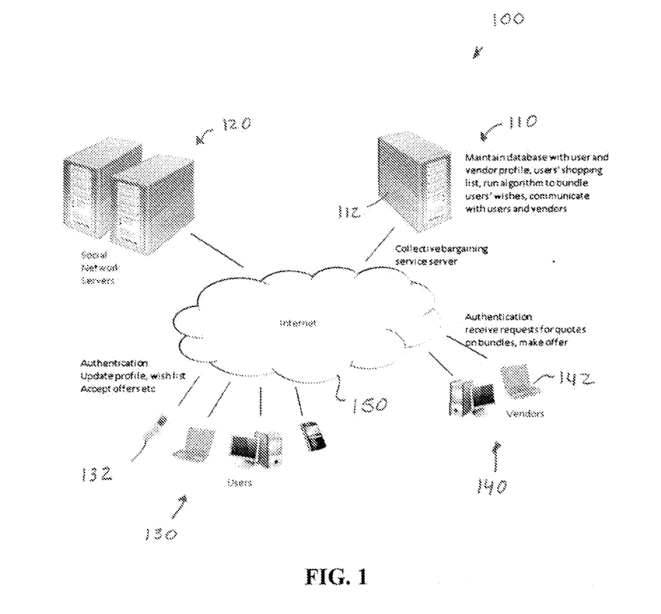

FIG. 1 is a schematic diagram of a system 100 for online purchases by a consumer collective service, which includes bargaining units in accordance with an exemplary embodiment. As shown in FIG. 1, the system 100 preferably includes at least one system server 110 (e.g., a collective bargaining service server), at least one social network server (or network connection) 120, one or more client devices 130 (or networking devices), and one or more vendor or business servers 140. Each of the servers and/or client devices 110, 120, 130, 140 preferably communicate with one another via a network connection 150, such as the Internet.

In accordance with an exemplary embodiment, the system server 110 manages a consumer collective service application (e.g., the service) 112. The system server 110 preferably includes a database of users, vendors, user's shopping list, software applications, which run algorithms to bundle user's wishes, and an ability to communicate with users and vendors.

In accordance with an exemplary embodiment, the system server 110 can be configured to obtain a request from a client device 130 and corresponding user 132 for the consumer collective service application. In accordance with an exemplary embodiment, the client devices 130 include a system software (or program), which the client devices 130 downloads from the system server 110, a client device readable medium or other suitable system or medium, which can provide the system software to the client device 130. The client device 130 is preferably a personal digital assistant (PDAs) such as a handheld computer, a small computer or a palmtop computer. The client device 130 includes software applications for authentication, updated profiles, wish list, accept offer and reject offers, and other applications associated with the consumer collective service 110.

In accordance with an embodiment, the client device 130 and/or personal digital assistant (PDA) includes access to a mobile network, network or network connection 150 in the form of the Internet, intranets or extranets via a cellular signal or frequency, a Wi-Fi signal (or Hotspots), a Wireless Wide-Area Networks (WWANs) or any medium that facilitates the transfer of data from the client software contained within the client device 130 to the system server 110 and vice versa. In addition, the vendors 142 includes a client device and/or server 140 having at least one software application and/or program, which receives requests for quotes on bundles of goods and/or services, and provides the vendor with the ability to provide and/or makes offers to users for the purchase of bundles of goods and/or services.

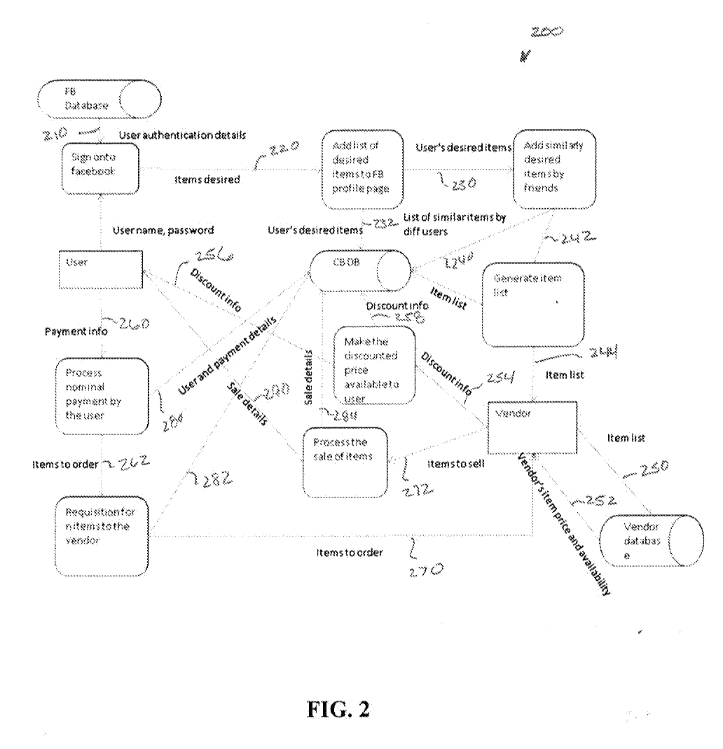

FIG. 2 is a flow diagram for online purchases by a consumer collective service 200, which includes bargaining units in accordance with an exemplary embodiment. As shown in FIG. 2, the consumer collective service 200, in step 210, a user preferably logs onto his or her social networking account (e.g., Facebook®), and on the user's profile, in step 220, the user adds items (e.g., “items desired”), which includes any goods and/or services in which the user desires to purchase and/or acquire. In accordance with an exemplary embodiment, in steps 230, the items desired are preferably made visible to the entire user's network of friends, friends of friends, etc. In step 232, the items desired are stored in a CB (collective bargaining) database on the collective system service server 110.

In accordance with an exemplary embodiment, in step 240, other users (and/or friends) add similarly desired items to the list, which are also stored in the collective bargaining (“CB”) database. In step 242, a list of similarly desired items is generated and sent to the vendor as a bundle of goods and/or services (step 244).

Once the vendor receives the list of similarly desired items, in step 250, the vendor's inventory is checked for availability of the goods and/or services, and in step 252, the availability of the goods and/or services is sent to the vendor, which generates a discount offer which can be sent to the plurality of users based on the vendor's desired item price and availability. In step 254, the vendor sends out the discounts and concessions he can make to the group of user and/or consumers for the purchase of the bundle of goods as proposed. In accordance with an exemplary embodiment, in step 256, this information is sent to the users (e.g., made available to the users at the discounted price) and appears on the user's profile page. It can be appreciated that this information is preferably visible to the entire network of user's friends, friends of friends etc. The vendor's discounted information is preferably stored in the “discount file” in the CB database via step 258.

In accordance with an exemplary embodiment, each of the users and/or consumers, which want to participate in the actual purchase of the goods and/or services, makes a commitment to the deal in step 260, wherein the users and/or consumers agree to pay a nominal amount for the transaction as a promise or guarantee that the user and/or consumer is willing and able to go through with the proposed offer. If the user and/or consumer decide that he or she is no longer interested in the goods and/or services, the nominal amount can be forfeited to the vendor, in whole or part. The commitment to the deal is processed in step 262. This information is stored in the “committed users” file in the CB database in steps 280, 282. In step 270, the user places a requisition for the quantity of items desired (stored in the “items to order” file) to the vendor. In step 272, the vendor processes the request (stored in the “sale” file). In step 290, the sale is processed, and the users and/or consumers obtain the items desired at a discounted price from the vendor.

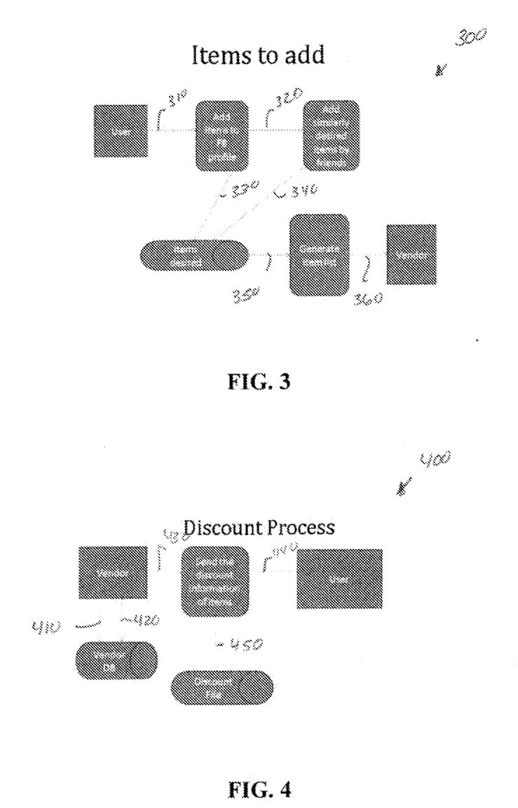

FIG. 3 is a flow diagram of a process for adding items (e.g., goods and/or services) to collective bargaining profile 300 in accordance with an exemplary embodiment. As shown in FIG. 3, in step 310, the user adds items to his or her social networking profile (e.g., Facebook profile or FB profile). In step 320, similarly desired items of friends and/or friends of friends are added to their corresponding social networking profile, which are then sent via steps 330, 340 to the collective bargaining database. In step 350, the collective bargaining database generates a list of desired items. The list of desired items is then sent to a vendor in step 360.

FIG. 4 is a flow diagram of a discount process 400 in accordance with an exemplary embodiment. As shown in FIG. 4, the vendor receives the list of desired items and in step 410 sends a request to the vendor's database to ascertain or determine an available quantity of the items desired. Once the available quantity of items desired has be ascertained or determined, the vendor in step 420 receives the information and in step 430 determines an offer for the bundle of desired items based on any suitable parameter set forth by the vendor. In step 440, the vendor sends the discount information based on available quantity and/or any other parameter as set forth by the vendor to a discount file database within the collective service server, and then sent to the user and/or consumers.

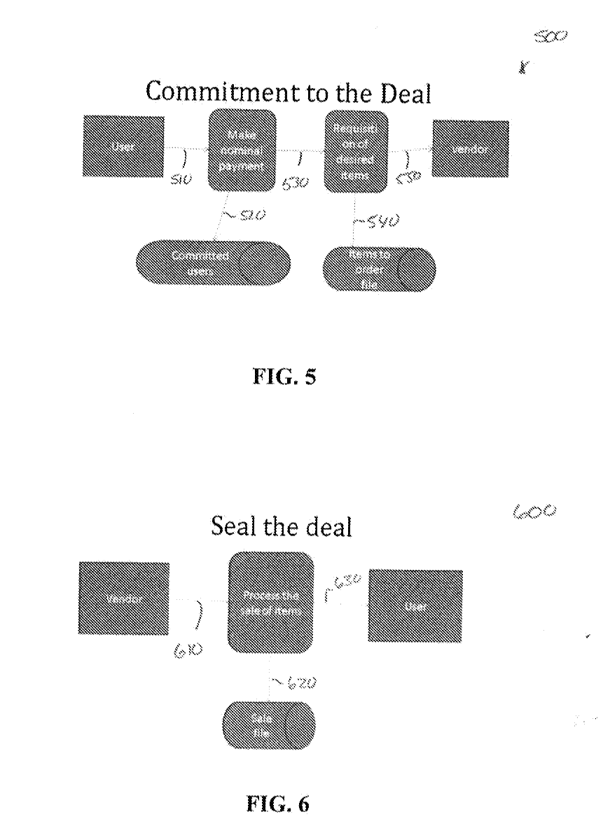

FIG. 5 is a flow diagram of a commitment to the deal 500 in accordance with an exemplary embodiment. As shown in FIG. 5, in step 510, once an offer from the vendor has been presented and accepted by the users and/or group of consumers, the users preferably make a nominal payment as a commitment to the deal (e.g., offer from the vendor). In step 520, a list of committed users is generated based upon the receipt of the nominal payments received from each of the committed users. Once a set number of committed users are reached, in step 530, a requisition of the desired items is generated and in step 540, an entry into the collective database is made confirming each of the users that have committed to the deal. In step 550, the information as to the number of committed users and/or consumers to the deal is then sent to the vendor (or seller).

FIG. 6 is a flow diagram of sealing the deal 600 in accordance with an exemplary embodiment. As shown in FIG. 6, in step 610, the process of sale of items is performed by the vendor. In association with sale, in step 620 a sale file is generated for tracking and book keeping procedures. In step 630, the goods and/or services are delivered to the plurality of users/consumers.

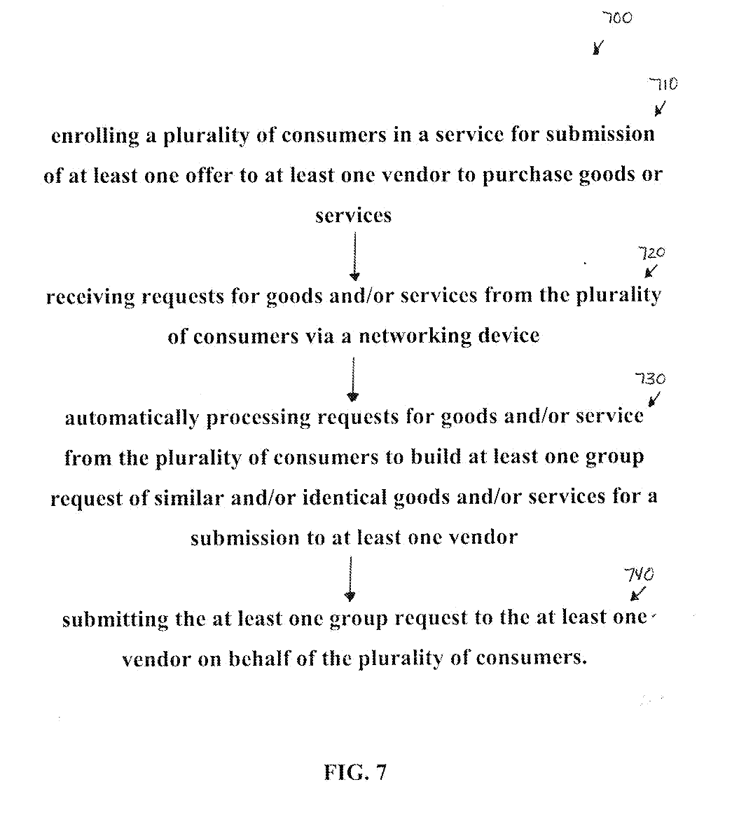

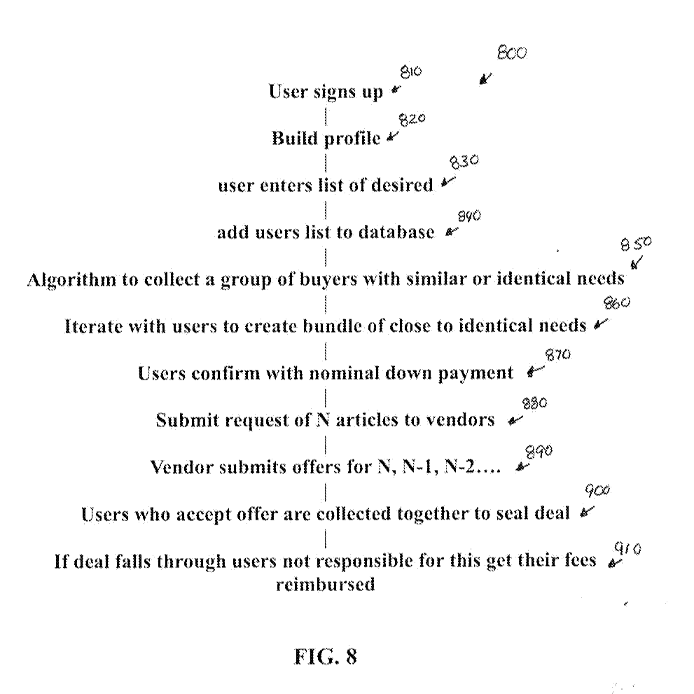

FIG. 7 is a flow chart of an exemplary embodiment for online purchases by a consumer collective service, which includes bargaining units 700 in accordance with another exemplary embodiment. As shown in FIG. 7, the method of facilitating a creation of customer groups for submission of an offer for a plurality of goods or services, the method includes in step 710, enrolling a plurality of consumers in a service for submission of at least one offer to at least one vendor to purchase goods or services; in step 720, receiving requests for goods and/or services from the plurality of consumers via a networking device 720; in step 730, automatically processing requests for goods and/or service from the plurality of consumers to build at least one group request of similar and/or identical goods and/or services for a submission to at least one vendor; and in step 740, submitting the at least one group request to the at least one vendor on behalf of the plurality of consumers.

FIG. 8 is a flow chart of another exemplary embodiment for online purchases by a consumer collective service, which includes bargaining units. As shown in FIG. 8, in step 810, the users (or consumers) enroll and/or sign up for the service on an application preferably via a social network and/or social networking system. However, it can be appreciated that enrollment can be through any suitable application and/or method in which users have access to the collective service. In step 820, the application builds a profile for the user based on basic information, which can include location, income bracket, age, etc. of each of the users. In step 830, the users maintains a list of goods and/or services they would like to buy or purchase, which typically include large ticket items (e.g., goods and/or services, which are often not purchased on an impulse, but rather research before purchase thereof). In step 840, the list of goods and/or services of the users are entered into a database associated with the consumer collective service for determination of users with similar and/or identical needs and/or requests.

In accordance with an exemplary embodiment, in step 850, a system of algorithms within the consumer collective service builds a group of consumers (or buyers) having similar or identical needs (e.g., a bundle of goods and services), which is attractive for vendors to offer special deals. It can be appreciated that this step preferably involve categorizing and collecting similar items together (e.g. hybrid cars), and notifying consumers or buyers in a given area or a group of friends (or friends” friends), and then facilitating the convergence of the varied orders (e.g., from different hybrid cars into a single group offer, for example, for a Toyota Prius). The offer is then packaged into a form that is appealing or attractive to vendors. It can be appreciated that in step 860, the process of generating a bundle of goods and services will include iterations of the list of goods and services on each of the users' list, such that a bundle of goods and services can be created, which is close to the needs and wants of the users, although it may not be identical. Once a potential bundle is generated, the consumer collective service will provide the bundle to the users, which will have an opportunity to accept (e.g., participate) the goods and services as offered and participate in the offer.

In accordance with an exemplary embodiment, in step 870, when given a go-ahead (e.g., confirmation and/or approval) by a group of users, in step 880, the application notifies vendors who have signed up for the service to make an offer. It can be appreciated that the notification to the vendors can be an electronic offers and/or solicitation, or alternatively, the service can have one or more sale representative and/or negotiators who will handle the negotiations on behalf of the group. In step 890, the vendors can accept the offer or solicitation, if the offer is made to only one vendor, or alternatively, if the offer is made to a plurality of vendors, a competitive bid or counter offer can be made to the initial offer or solicitation from the users. In accordance with an exemplary embodiment, in step 900, the users or customer group selects from a competitive bid and proceeds to close the deal, making savings not possible on their own. It can be appreciated that in step 910, if the deal falls through and/or is not made, any fees, which were submit as a good faith offer of the users' participation in the offer or solicitation is refunded and/or returned. In accordance with an exemplary embodiment, each of the negotiation steps can be iterated as required.

It can be appreciated that the customer groups service as described herein is different from other services, such as online reverse auctions (e.g. Priceline®), which are one on one deals, usually involving surplus inventory. Furthermore, one of the key features of the customer group services is the ability for the users to form small collective bargaining units in a simple, effortless manner. Alternatively, group deals (e.g. Groupon) are typically services where the operators themselves seek deals based on the size of their membership, as opposed to the customer group services where the users themselves are empowered to make the deals. Meanwhile, online trading/auction sites (e.g. eBay®, Amazon®) are built on traditional trading methods with no social shopping features.

In accordance with an exemplary embodiment, the method and system as described herein is preferably implemented on a social networking site, such as Facebook®. For example, with a social networking site, a user (or consumer) using a client device having a graphical user interface (GUI), can click on a link on Facebook (e.g., an ad or wall posting by a friend, message in inbox etc.) to enroll in consumer collective service as described herein. In accordance with an exemplary embodiment, a pop-up confirms the enrollment of the user or consumer in the consumer collective service. The pop-up has check box, when ticked, to announce enrolment on “wall post”, as well as the ability of the user to “accept” the user agreement associated with the customer group service. In accordance with an exemplary embodiment, a profile created on server for a new user, the consumer collective service shows up on the user's list of applications on Facebook.

In accordance with an exemplary embodiment, when the user and/or consumer selects the consumer collective service application, a client window opens with one or more of the following options: “edit profile” (e.g., additional personal information, address, credit card information, etc.); “shopping list” (e.g., user enters items, which the user is looking to buy in the near future); “search bundles” (e.g., bundles of goods and/or services, which are being formed or generated); “invite friends” (e.g., make invitation through Facebook); “help” (e.g., provides help for users); “edit profile” (e.g., change and/or modify personal information, address, credit card information, etc.); user selects “shopping list”; and “existing list” (e.g., goods and/or services) is displayed; and “add to list”.

In accordance with another exemplary embodiment, the user and/or consumer user can click on any item to edit, delete, park (e.g., maintained in users database, but not used in algorithm to build bundles), post on wall, and/or send to friends. Additional commands can include “add to list” takes user to a table to enter following items (“edit item” also brings user to same table, but with cells already filled). In accordance with a further embodiment, the user interface include one or more layers of pull-down menus to select category and sub-categories (e.g. Automobile>Make>Model>Year, or Electronics>TV>Make>LCD>52″), then a box to enter other specifications (e.g., 4 cycle, white, leather seats, etc.), preferred delivery method, acceptable lead time (e.g. <1 wk, <1 mo, <3 mo, this year, etc), and/or exclude certain goods and/or services.

In accordance with a further exemplary embodiment, the application user interface includes “search bundles”, which can include standard search functions to find suitable bundles, and sort, and/or mark favorite goods and/or services. Alternatively, the application can include and/or use a key word search. In addition, the consumer collective service can include a help function, which includes information about the service including a description of service, FAQ (frequently asked questions), and contact information for consumer collective service.

The consumer collective service preferably includes an algorithm (and associated computer code), which runs continuously on a server with an algorithm, which includes: database searched to find large groups with same high level specifications (e.g. make, model, year, of car, geographic location, including zip code, lead time), which creates a “potential bundle” of goods and/or services. It can be appreciated that if identical sets of goods and/or services exist (or similar goods and/or services), then those goods and/or services form a “core bundle”. Alternatively, the algorithm finds or searches for a particular specification (e.g., similar goods and/or services), which can be used to create “potential bundle” having at least a minimum size, and more preferably the bundle has the largest number of users and/or goods as possible. The algorithm can also set a time frame (or deadline) by which to consolidate lists of goods and/or services. It can be appreciated that a notification is preferably sent to everyone on a “potential bundle” with suggested changes to their specification (if required), and deadline to make changes by, and confirm that the user and/or consumer would like to participate in the current “potential bundle”.

In accordance with an exemplary embodiment, the user and/or consumer clicks on a confirmation button, e.g., “confirm”, which takes the user and/or consumer to page listing conditions, which can includes a commitment to customer group service fees. The customer group service fee is a fee, which will be charged if the user and/or consumer drops out after the vendor makes offer. The fee can be a percentage of the estimate price for the goods and/or services (e.g., approximately 1% of MSRP (manufacturer's suggested retail price) times number of users that accept deal/number of bundle members), a set fee, and/or alternatively, an exponential curve calculation.

In accordance with another exemplary embodiment, the customer group service can include an option to allow the service to post on user's wall with imminent bundle (including running tally of confirmed number of members). It can be appreciated that after the deadline is reached, the bundle is placed on at least one vendor's site and notification sent to relevant vendors to make an offer within a specified time (e.g., a day for cars, approximately 1 hour for software, etc.). In accordance with an exemplary embodiment, the specified time is based on the type of goods and/or services.

Each of the vendors can make their bids, and the collective consumer service selects the lowest bid and sends notification to bundle members (as well as listing on their profile page). Each user (e.g., consumer) preferably confirms and acknowledges acceptance or alternatively, rejection of the vendor's offer by a specified time. In addition, each of the vendors also preferably receives a nominal payment if the offer is accepted, which the vendor retains if one or more of the users or participates fails to follow through with the purchase of goods or services upon the agreed to terms of the group offer.

In accordance with another exemplary embodiment, each of the vendor should also select what volume (e.g., number of units) that the vendor needs to guarantee a set price (e.g., 100%, or down to N−1, or N−2 etc.). The service also provides a functionality for vendors to register and maintain profiles, which can include geographic location, goods and products sold, services offered, and other key words) on the server. It can be appreciated that the customer group service can also facilitate creation of customer “collectives” to negotiate better prices from vendors based on the power of higher volume. It can be appreciated that social networks and the Internet can be used to facilitate this exercise with minimal effort from buyers. It can be appreciated that services such as the customer group service as described herein, adds value to the market place by increasing efficiency, helping to reduce inventory in the system, and generally reducing overheads and waste.

In accordance with an exemplary embodiment, one differentiation between the disclosed method and system as disclosed herein, and other popular schemes out there is that they all are invariably originated from the supply side, for example, a vendor giving discounts for whatever reason under certain conditions. These types of popular schemes can be time limited, promotional in nature, tied to some clearance sales, etc. They can also be facilitated by a third party, for example, Groupon. In accordance with an exemplary embodiment, the offer to make a volume purchase as disclosed herein is originated from the demand side. Thus, individual consumers work together to build a purchase volume, which is at a significant level to be able to negotiate with vendors. Since no such service exists today, the present disclosure provides a unique and novel approach not previously disclosed.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A method of facilitating a creation of group of customers and soliciting an offer for a plurality of goods or services, the method comprising:
enrolling a plurality of consumers in a service for submission of at least one offer to at least one vendor to purchase goods or services;
receiving requests for goods and/or services from the plurality of consumers via a networking device;
automatically processing requests for goods and/or service from the plurality of consumers to build at least one group request of similar and/or identical goods and/or services for a submission to at least one vendor; and
submitting the at least one group request to the at least one vendor on behalf of the plurality of consumers.

2. The method of claim 1, comprising:
relaying an offer back to the plurality of consumers to confirm or decline participation in a group deal; and
finalizing the group deal with a final set of consumers and a price agreed to by the at least one vendor for a given size of group.

3. The method of claim 1, wherein the requests for goods and/or services are grouped into a classification so that goods and/or services of similar and/or identical needs can be determined.

4. The method of claim 1, comprising:
performing an iteration between consumers and the at least one vendor to generate a larger bundle of request for similar and/or identical goods and/or services for submission to the at least one vendor;
notifying each of the plurality of consumers within a group of the bundle of request for similar and/or identical goods and/or services as generated; and
requesting each of the plurality of consumers to authorize or opt out of the submission thereof for submission to the at least one vendor.

5. The method of claim 1, comprising:
requiring payment or commitment to pay a portion of a total purchase price for goods and/or services by each of the plurality of consumers before the submission of the at least one group request to the at least one vendor.

6. The method of claim 1, comprising:
submitting each of the at least one group request to a plurality of vendors on behalf of the consumer; and
placing the each of the at least one group request up for bid by a plurality of vendors and selecting the most attractive offer for the consumers, and wherein each of the plurality of vendors enters varying prices for their goods and services as a function of the quantity and/or size of an order.

7. The method of claim 6, comprising:
offering transfer functions including exponential, log and/or polynomial curves relating price to volume to the at least one vendor to select from and set a varying price for the goods and services of the at least one vendor.

8. The method of claim 1, comprising:
confirming an order of the plurality of consumers based on a selected offer from the at least one vendor.

9. The method of claim 1, comprising:
providing a reward system by which each of the plurality of consumers is rewarded based on how early each of the plurality of consumers respond to a selected offer and commit to the selected offer.

10. The method of claim 9, comprising:
penalizing each of the plurality of consumers in the reward system that commit to an order and later back out.

11. The method of claim 1, comprising:
enrolling the plurality of consumers and/or the plurality of vendors via a social network.

12. The method of claim 1, wherein each of the plurality of consumers has a consumer profile, and the consumer profile includes one or more of the following: location of the consumer, income bracket, age, interests, shopping history, friend list, and/or wish list of items for future purchase.

13. The method of claim 1, comprising:
providing an interactive site, wherein each of the plurality of consumers can search for goods and/or services, which each of the plurality of consumers are interested.

14. The method of claim 1, comprising:
receiving notification of group requests, which are going to be submitted to the at least one vendor prior to the submission thereof.

15. The method of claim 1, comprising:
determining a price for the offer, the price being a reduction in amount from a standard offer price of the goods and/or services.

16. The method of claim 1, comprising
providing a commission to the at least one vendor before the at least one vendor offers the goods and/or services to the plurality of consumers.

17. A method of facilitating a creation of group of customers for soliciting an offer for a plurality of goods or services, the method comprising:
enrolling a plurality of consumers in a service for submission of at least one group request to at least one vendor to purchase goods or services;
receiving requests for goods and/or services from the plurality of consumers via a networking device;
suggesting goods and/or services to the plurality of consumers via a networking device; and
submitting the at least one group request to the at least one vendor on behalf of the plurality of consumers.

18. A system for facilitating a creation of customer groups for soliciting an offer for a plurality of goods or services, the system comprising:
a system server for managing an application, the application performing the following steps:
enrolling a plurality of consumers in a service for submission of at least one group request to at least one vendor to purchase goods or services;
receiving requests for goods and/or services from the plurality of consumers via a networking device;
grouping the requests for goods and/or service from the plurality of consumers for a submission to at least one vendor; and
submitting the at least one group request to the at least one vendor on behalf of the plurality of consumers; and
one or more client devices, which receive the customer group application from the system server via a network.

19. The system of claim 18, wherein the requests for goods and/or services are group into a classification so that goods and/or services of similar and/or identical needs can be determined.

20. The system of claim 18, comprising:
performing an iteration of the request for similar and/or identical goods and/or services to generate a bundle of similar and/or identical goods and/or services for submission to the at least one vendor.

21. The system of claim 20, comprising:
notifying each of the plurality of consumers of the bundles of similar and/or identical goods and/or services for submission to the at least one vendor and requesting each of the plurality of consumers to authorize the submission thereof for submission to the at least one vendor; and/or
requiring a portion of a total purchase price for goods and/or services to be provided by each of the plurality of consumers before the submission of the at least one customer group request to the at least one vendor.

22. The system of claim 18, comprising:
submitting each of the at least one customer group request to a plurality of vendors on behalf of the consumer; and
submitting each of the at least one customer group request to a plurality of vendors comprises placing the each of the least one customer group requests up for bid.

23. The system of claim 18, comprising:
an interactive site, wherein each of the plurality of consumers can search for goods and/or services, which each of the plurality of consumers are interested, and which:
receives notification of consumer collective requests, which are going to be submitted to the at least one vendor prior to the submission thereof; and
determines a price for the consumer collective request, the price being a reduction in amount from a standard offer price of the goods and/or services.

24. The system of claim 18, comprising:
an algorithm and/or software application that balances building as large a group of consumers as possible while retaining a minimal set of common specifications that vendors can respond to. This expert system will be designed to learn from past experience and improve continuously.

25. The system of claim 18, wherein the algorithm and software application:
analyzes the requests to generate a specification for goods and services expected to satisfy a large number of consumers; and
provides a sliding scale of expected price based on number of consumers committed to purchase at any given time.
